(19) United States
(12) Patent Application Publication
(10) Pub. No.: US 2012/0287839 A1
(43) Pub. Date: Nov. 15, 2012

(54) METHOD AND APPARATUS FOR UPDATING MULTICAST AND BROADCAST SERVICE

(75) Inventors: Eunkyung Kim, Daejeon (KR); Jae Sun Cha, Daejeon (KR); Soojung Jung, Daejeon (KR); Sung Cheol Chang, Daejeon (KR); Kwang Jae Lim, Daejeon (KR); Hyun Lee, Daejeon (KR); Chul Sik Yoon, Seoul (KR)

(73) Assignee: Electronics And Telecommunications Research Institute, Daejeon (KR)

(21) Appl. No.: 13/521,628

(22) PCT Filed: Jan. 11, 2011
(86) PCT No.: PCT/KR2011/000183

§ 371 Date: Jul. 11, 2012

(30) Foreign Application Priority Data
Jan. 12, 2010 (KR) 10-2010-0002479
Sep. 8, 2010 (KR) 10-2010-0087788
Jan. 11, 2011 (KR) 10-2011-0002695

(51) Int. Cl. H04W 4/06

(52) U.S. Cl. 370/312

(57) ABSTRACT

When MBS information is updated, a base station transmits a first message to a terminal. The first message includes a service flow update indicator for indicating a scheme for describing a current MBS identifier (ID) and flow ID to be updated, information on the current MBS ID and flow ID described by the scheme indicated by the service flow update indicator, and new MBS information. The terminal transmits a second message to the base station in response to the first message.

### BACKGROUND

(a) Field

The present invention relates to a method and apparatus for updating multicast and broadcast service (MBS).

(b) Description of the Related Art

The MBS is a point-to-multipoint transmission method for concurrent transport of data packets from a source to a plurality of destinations. Broadcast service means a transmission service where data packets are transmitted to all terminals, and multicast service means a transmission service where data packets are transmitted to terminals belonging to a specific group.

The MBS has a certain QoS parameter and a service flow, and is serviced through mapping them to a plurality of terminals simultaneously.

A terminal establishes the QoS parameter and service flow to receive the MBS. Each base station capable of providing the MBS belongs to a certain MBS zone, and one base station can belongs to multiple MBS zones. An identifier (MBS ID) is used for transmitting content of a certain service flow within each MBS zone. The MBS ID is a common identifier that is allocated to a terminal for receiving MBS. The MBS contents are transmitted to an area that is classified as a zone, and the MBS zone is identified by a unique identifier (MBS zone ID). The MBS contents have the same channel or service flow identifier (FID). The FID is used along with a corresponding MBS ID and is allocated to each MBS connection. Several FIDs can be allocated to one terminal, and a specific MBS content is identified by the FID in a domain of one MBS zone.

In an MBS zone, a terminal should be continuously provided with MBS regardless whether it is in a connected state (a state including a normal mode or a sleep mode) or an idle state (a state including an idle mode).

### SUMMARY

Aspects of the present invention provide an MBS update method and apparatus for providing MBS regardless of the state of the terminal.

According to an aspect of the present invention, a method of updating MBS in a base station is provided. The method includes transmitting a first message to a terminal when MBS information is updated, and receiving a second message in response to the first message from the terminal. The first message includes a service flow update indicator for indicating a scheme for describing a current MBS identifier (ID) and flow ID to be updated, information on the current MBS ID and flow ID described by the scheme indicated by the service flow update indicator, and new MBS information.

The information on the current MBS ID and flow ID may be the current MBS ID and flow ID when the service flow update indicator has a first value. The information on the current MBS ID and flow ID may be an index for a combination of the current MBS ID and flow ID when the service flow update indicator has a second value.

The index may be defined by a bitmap format where a plurality of combinations of MBS IDs and flow IDs are sorted with certain order and correspond to a plurality of bits respectively.

A value of a bit corresponding to the combination of the current MBS ID and flow ID among the plurality of bits may be ‘1’.

The new MBS information may include a new MBS ID and flow ID mapped to the current MBS ID and flow ID.

A case in which the MBS information is updated may be a case in which an MBS zone is updated. Here, the new MBS information may include a new MBS zone ID.

The first message may further include a current MBS zone ID.

The first message may further include information on a carrier supported in a new MBS zone when the carrier supported in the new MBS zone is different from a carrier supported in a current MBS zone.

The first message may further include information on a carrier switching time.

A method of updating MBS in a base station according to another aspect of the present invention includes receiving a ranging request message from a terminal, and transmitting a ranging response message to the terminal when MBS information is updated. The ranging response message includes a service flow update indicator, information on a current MBS ID and flow ID to be updated which are described by a value of the service flow update indicator, and new MBS information. The information on the current MBS ID and flow ID is the current MBS ID and flow ID when the service flow update indicator has a first value. The information on the current MBS ID and flow ID is an index for a combination of the current MBS ID and flow ID when the service flow update indicator has a second value.

A method of updating MBS in a base station according to yet another aspect of the present invention includes receiving a dynamic service change request message from a terminal, and transmitting a dynamic service change response message to the terminal when MBS information is updated. The dynamic service change response message includes a service flow update indicator, information on a current MBS ID and flow ID to be updated which are described by a value of the service flow update indicator, and new MBS information. The information on the current MBS ID and flow ID is the current MBS ID and flow ID when the service flow update indicator has a first value. The information on the current MBS ID and flow ID is an index for a combination of the current MBS ID and flow ID when the service flow update indicator has a second value.

A method of updating MBS in a base station according to yet another aspect of the present invention includes transmitting a dynamic service change request message to a terminal when MBS information is updated, and receiving a dynamic service change response message from the terminal. The dynamic service change request message includes a service flow update indicator, information on a current MBS ID and flow ID to be updated which are described by a value of the service flow update indicator, and new MBS information. The information on the current MBS ID and flow ID is the current MBS ID and flow ID when the service flow update indicator has a first value. The information on the current MBS ID and flow ID is an index for a combination of the current MBS ID and flow ID when the service flow update indicator has a second value.

According to yet another aspect of the present invention, a method of updating MBS in a terminal is provided. The method includes receiving a first message from a base station when MBS information is updated, and transmitting a second message in response to the first message to the base station. The first message includes a service flow update indicator for indicating a scheme for describing a current MBS identifier (ID) and flow ID to be updated, information on the current MBS ID and flow ID described by the scheme indicated by the service flow update indicator, and new MBS information.

A method of updating MBS in a terminal according to yet another aspect of the present invention includes transmitting a ranging request message to a base station, and receiving a ranging response message from the base station when MBS information is updated. The ranging response message includes a service flow update indicator, information on a current MBS ID and flow ID to be updated which are described by a value of the service flow update indicator, and new MBS information. The information on the current MBS ID and flow ID is the current MBS ID and flow ID when the service flow update indicator has a first value. The information on the current MBS ID and flow ID is an index for a combination of the current MBS ID and flow ID when the service flow update indicator has a second value.

A method of updating MBS in a terminal according to yet another aspect of the present invention includes transmitting a dynamic service change request message to a base station; and

receiving a dynamic service change response message from the base station when MBS information is updated, the dynamic service change response message comprising a service flow update indicator, information on a current MBS ID and flow ID to be updated which are described by a value of the service flow update indicator, and new MBS information,

wherein the information on the current MBS ID and flow ID is the current MBS ID and flow ID when the service flow update indicator has a first value, and

wherein the information on the current MBS ID and flow ID is an index for a combination of the current MBS ID and flow ID when the service flow update message to a base station, and receiving a dynamic service change response message from the base station when MBS information is updated. The dynamic service change response message includes a service flow update indicator, information on a current MBS ID and flow ID to be updated which are described by a value of the service flow update indicator, and new MBS information. The information on the current MBS ID and flow ID is the current MBS ID and flow ID when the service flow update indicator has a first value. The information on the current MBS ID and flow ID is an index for a combination of the current MBS ID and flow ID when the service flow update indicator has a second value.

A method of updating MBS in a terminal according to yet another aspect of the present invention includes receiving a dynamic service change request message from a base station when MBS information is updated, and transmitting a dynamic service change response message to the base station. The dynamic service change request message includes a service flow update indicator, information on a current MBS ID and flow ID to be updated which are described by a value of the service flow update indicator, and new MBS information. The information on the current MBS ID and flow ID is the current MBS ID and flow ID when the service flow update indicator has a first value. The information on the current MBS ID and flow ID is an index for a combination of the current MBS ID and flow ID when the service flow update indicator has a second value.

According to an embodiment of the present invention, even though the MBS information is updated, MBS is continuously provided through the MBS update request message regardless of the state of the terminal.

### BRIEF DESCRIPTION OF THE DRAWINGS

FIG. 1 is a schematic flowchart of an MBS supporting method according to an embodiment of the present invention.

FIG. 2 is a schematic flowchart of an MBS updating method according to an embodiment of the present invention.

FIG. 3 shows an MBS update request message according to an embodiment of the present invention.

FIG. 4 is a schematic block diagram of an MBS updating apparatus according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term terminal may designate a mobile terminal (MT), a mobile station (MS), a subscriber station (SS), a portable subscriber station (PSS), an access terminal (AT), a user equipment (UE) and so on, or may include all or some functions thereof.

Further, the term base station (BS) may designate a node B, an evolved node B (eNodeB), an access point (AP), a radio access station (RAS), a base transceiver station (BTS), an MMR (mobile multihop relay)-BS and so on, or may include all or some functions thereof.

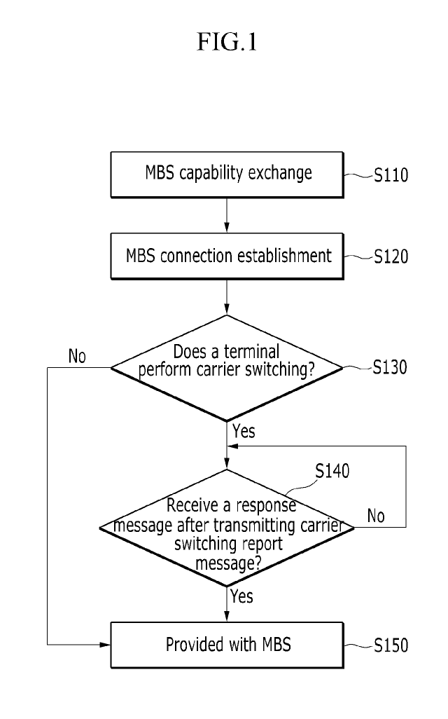

FIG. 1 is a schematic flowchart showing an MBS supporting method according to an embodiment of the present invention.

Referring to FIG. 1, a terminal transmits information on MBS modes which can be supported by the terminal to a base station, and the base station transmits to the terminal information on MBS modes which can be supported by the base station among the MBS modes supported by the terminal (S110). MBS capability is exchanged between the base station and the terminal. The terminal may transmit MBS mode information by using a registration request (REG-REQ) message for requesting registration of network entry or network re-entry. The base station may transmit MBS mode information by using a registration response (REG-RSP) message to REG-REQ message.

Next, the base station transmits to the terminal a message including MBS parameter for establishing MBS connection, and the terminal transmits to the base station a response message thereto (S120). The response message may include MBS parameters. The MBS parameters may include an MBS service flow parameter, an MBS zone ID and MBS carrier information. The MBS service flow parameter includes an MBS ID for identifying MBS and a MBS service flow identifier (FID) used along with the MBS ID.

The base station may transmit MBS parameter by using a dynamic service addition request (DSA-REQ) message, and the terminal may use a dynamic service addition response (DSA-RSP) message as a response message to DSA-REQ message. Meanwhile, a terminal may initiate an MBS connection establishment request. In this case, the terminal may transmit DSA-REQ message to the base station, and the base station may transmit DSA-RSP message to the terminal.

As described above, after MBS connection is established through DSA-REQ/RSP message exchange, the terminal receives the MBS from the base station (S150).

When the MBS is provided through multi-carrier, the terminal may perform carrier switching after the MBS connection is established (S130). In this case, when the terminal transmits to the base station an MBS report (MBS-REP) message for reporting carrier switching and receives an MBS response (MBS-RSP) message as a response to MBS-REP message from the base station (S140), the MBS is provided to the terminal (S150). The terminal may transmit MBS-REP message to the base station, thereby requesting a start time of MBS carrier switching, or informing the base station a stopping time of MBS carrier switching (i.e., a time for returning to a primary carrier) without releasing the MBS connection.

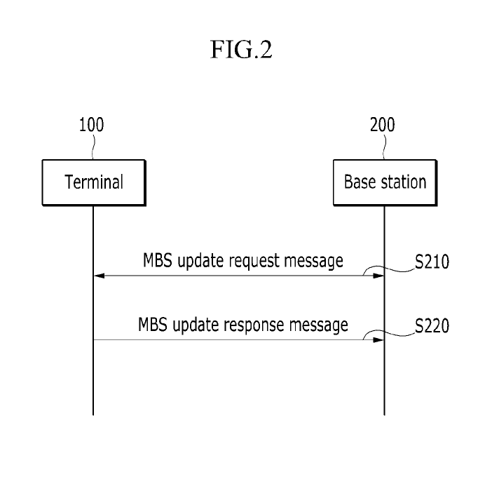

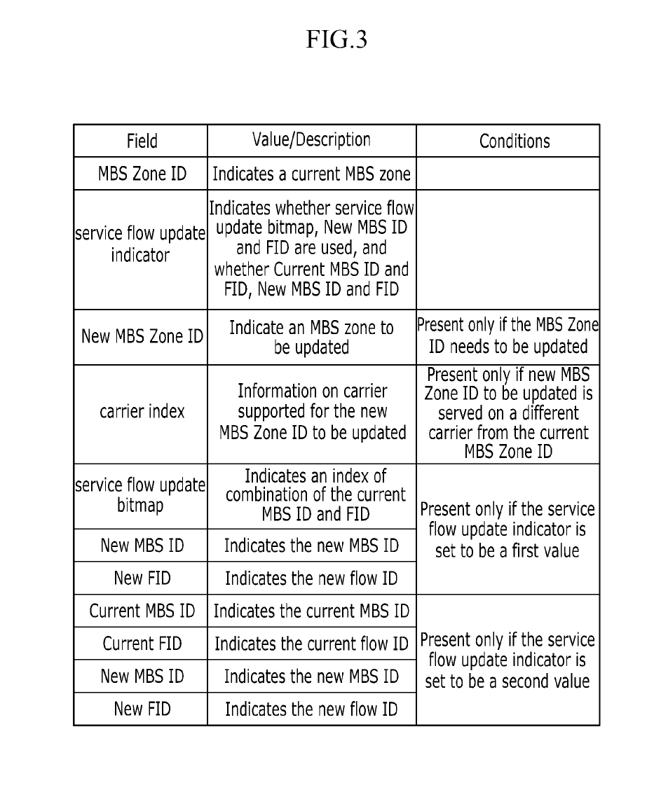

MBS service flow may be changed after the MBS connection is established through the above-described procedure. Hereinafter, an MBS updating method in case that the MBS service flow is changed will be described referring to FIG. 2 and FIG. 3.

FIG. 2 is a schematic flowchart of an MBS updating method according to an embodiment of the present invention, and FIG. 3 shows an MBS update request message according to an embodiment of the present invention.

First, the examples of MBS service flow change may include 1) a case that MBS zone is changed but MBS ID and FID are not changed, 2) a case that all of MBS zone, MBS ID and FID are changed, and 3) a case that MBS ID and FID are changed but MBS zone is not changed.

When the MBS service flow is changed, a base station 200 recognizes MBS information change of current MBS zone and/or a neighboring MBS zone (S210). Then, the base station 200 transmits to a terminal 100 an MBS update request message for updating MBS information of the terminal 100 (S220). The terminal 100 transmits a response message thereto to the base station 200 (S230). The terminal 100 and the base station 200 may update MBS information by exchanging the MBS update request/response message.

A medium access control (MAC) control message may be used as the MBS update request/response message. For example, a dynamic service change request (DSC-REQ) message may be used as the MBS update request message, and a dynamic service change response (DSC-RSP) message may be used as a response message to the DSC-REQ message.

When the terminal performs hand-over, the terminal may transmit a ranging request (RNG-REQ) message to the base station and receive a ranging response (RNG-RSP) message from the base station. The terminal in idle mode may transmit a RNG-REQ message for location update to the base station and receive a RNG-RSP from the base station. The base station may use the RNG-RSP message as the MBS update request message to update the MBS of the terminal.

In addition, the service flow information of the neighboring zone may be transmitted through the MBS configuration (MBS-CFG) message. In this case, the terminal may update MBS information through receiving MBS-CFG message when its cell is changed or the lifetime of MBS information is expired.

Referring to FIG. 3, the MBS update request message includes current MBS zone ID for indicating current MBS zone where the current connection is valid, and further includes new MBS zone ID when the MBS zone is changed.

When a carrier that is used in the new MBS zone ID is different from the carrier that is used in the current MBS zone ID at the time of MBS zone change, the MBS update request message includes information (i.e. carrier index) on carrier that is supported by the new MBS zone ID.

When the MBS service flow parameter is changed, the MBS update request message includes current service flow information and new service flow information. Two schemes may be considered to indicate current service flow information. One is to directly use current MBS ID and FID. The other is to use an index corresponding to an order when a combination of MBS ID and FID is sorted with certain order, for example increasing order or decreasing order. Thus, the MBS update request message includes a service flow update indicator to represent which of them is used. That is, a value of the service flow update indicator identifies one of the two schemes.

When directly using current MBS ID and FID, the MBS update request message includes current MBS ID and current FID, and further includes new MBS ID and new FID that are mapped to current MBS ID and current FID, respectively.

When using the index of the combination of MBS ID and FID, the MBS update request message includes the index of the combination of current MBS ID and current FID, and further includes new MBS ID and new FID that are mapped to current MBS ID and current FID, respectively. A service flow update bitmap of a bitmap format may be used as the index. Each bit of the service flow update bitmap including a plurality of bits (for example, 16 bits) may be matched to each combination of MBS ID and FID, and the bit corresponding to the combination of the new MBS ID and FID to be updated may be set as ‘1’.

In addition, the MBS update request message may further include a transmission period and/or a transmission area of the control information.

Furthermore, when the terminal receives the MBS through carrier switching, the MBS update request message may further include carrier switching time. The carrier switching time includes at least one of a switching time of MBS carrier and a time of returning to a primary carrier. The carrier switching time may be allocated per MBS zone or per terminal regardless of MBS zone. The base station may inform the terminal the carrier switching time by transmitting MBS-RSP message to the terminal when the terminal requests carrier switching through MBS-REP message, or the base station may inform the terminal the carrier switching time by transmitting the MBS-RSP message to the terminal without the request from the terminal.

Meanwhile, the MBS update request message may not include the current MBS information and may include only the new MBS information. In this case, the current value of the MBS information may be replaced with the new value.

While it has been described that the base station transmits the MBS update request message to the terminal in FIG. 2 and FIG. 3, the terminal may request the base station to update the MBS. In this case, the terminal may request the base station to update the MBS using the DSC-REQ message described above, and the base station may transmit the DSC-RSP message to the terminal in response to the DSC-REQ message. The DSC-RSP message includes information corresponding to the MBS update request message. The registration response (REQ-RSP) message described in FIG. 1 may be used as the MBS update request message.

As described above, according to an embodiment of the present invention, even though the MBS information is updated, MBS is continuously provided through the MBS update request message regardless of the state of the terminal.

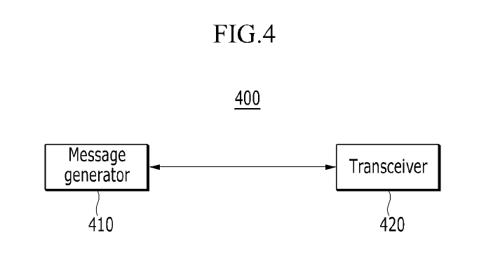

Hereinafter, an MBS updating apparatus that may perform the MBS updating method according to an embodiment of the present invention will be described with reference to FIG. 4.

FIG. 4 is a schematic diagram showing an MBS updating apparatus according to an embodiment of the present invention.

Referring to FIG. 4, the MBS updating apparatus 400 includes a message generator 410 and a transceiver 420. The message generator 410 generates MBS information update request message when the MBS service flow is changed. The transceiver 420 transmits the MBS information update request message to the other node and receives MBS information update response message from the other node. If the MBS updating apparatus 400 is included in the base station 200 or is the base station 200, the transceiver 420 transmits the MBS information update request message to the terminal 100. If the MBS updating apparatus 400 is included in the terminal 100 or is the terminal 100, the transceiver 420 transmits the MBS information update request message to the base station 200.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of updating multicast and broadcast service (MBS) in a base station, the method comprising:
transmitting a first message to a terminal when MBS information is updated, the first message comprising a service flow update indicator for indicating a scheme for describing a current MBS identifier (ID) and flow ID to be updated, information on the current MBS ID and flow ID described by the scheme indicated by the service flow update indicator, and new MBS information; and
receiving a second message in response to the first message from the terminal.

2. The method of claim 1, wherein the information on the current MBS ID and flow ID is the current MBS ID and flow ID when the service flow update indicator has a first value, and
wherein the information on the current MBS ID and flow ID is an index for a combination of the current MBS ID and flow ID when the service flow update indicator has a second value.

3. The method of claim 2, wherein the index is defined by a bitmap format where a plurality of combinations of MBS IDs and flow IDs are sorted with certain order and correspond to a plurality of bits respectively.

4. The method of claim 3, wherein a value of a bit corresponding to the combination of the current MBS ID and flow ID among the plurality of bits is ‘1’.

5. The method of claim 1, wherein the new MBS information comprises a new MBS ID and flow ID mapped to the current MBS ID and flow ID.

6. The method of claim 1, wherein a case in which the MBS information is updated comprises a case in which an MBS zone is updated, and
wherein the new MBS information comprises a new MBS zone ID.

7. The method of claim 1, wherein the first message further comprises a current MBS zone ID.

8. The method of claim 1, wherein the first message further comprises information on a carrier supported in a new MBS zone when the carrier supported in the new MBS zone is different from a carrier supported in a current MBS zone.

9. The method of claim 8, wherein the first message further comprises information on a carrier switching time.

10. A method of updating multicast and broadcast service (MBS) in a base station, the method comprising:
receiving a ranging request message from a terminal; and
transmitting a ranging response message to the terminal when MBS information is updated, the ranging response message comprising a service flow update indicator, information on a current MBS ID and flow ID to be updated which are described by a value of the service flow update indicator, and new MBS information,
wherein the information on the current MBS ID and flow ID is the current MBS ID and flow ID when the service flow update indicator has a first value, and
wherein the information on the current MBS ID and flow ID is an index for a combination of the current MBS ID and flow ID when the service flow update indicator has a second value.

11. A method of updating multicast and broadcast service (MBS) in a base station, the method comprising:
receiving a dynamic service change request message from a terminal; and
transmitting a dynamic service change response message to the terminal when MBS information is updated, the dynamic service change response message comprising a service flow update indicator, information on a current MBS ID and flow ID to be updated which are described by a value of the service flow update indicator, and new MBS information,
wherein the information on the current MBS ID and flow ID is the current MBS ID and flow ID when the service flow update indicator has a first value, and
wherein the information on the current MBS ID and flow ID is an index for a combination of the current MBS ID and flow ID when the service flow update indicator has a second value.

12. A method of updating multicast and broadcast service (MBS) in a base station, the method comprising:
transmitting a dynamic service change request message to a terminal when MBS information is updated, the dynamic service change request message comprising a service flow update indicator, information on a current MBS ID and flow ID to be updated which are described by a value of the service flow update indicator, and new MBS information; and
receiving a dynamic service change response message from the terminal,
wherein the information on the current MBS ID and flow ID is the current MBS ID and flow ID when the service flow update indicator has a first value, and
wherein the information on the current MBS ID and flow ID is an index for a combination of the current MBS ID and flow ID when the service flow update indicator has a second value.

13. A method of updating multicast and broadcast service (MBS) in a terminal, the method comprising:
receiving a first message from a base station when MBS information is updated, the first message comprising a service flow update indicator for indicating a scheme for describing a current MBS identifier (ID) and flow ID to be updated, information on the current MBS ID and flow ID described by the scheme indicated by the service flow update indicator, and new MBS information; and
transmitting a second message in response to the first message to the base station.

14. A method of updating multicast and broadcast service (MBS) in a terminal, the method comprising:
transmitting a ranging request message to a base station; and
receiving a ranging response message from the base station when MBS information is updated, the ranging response message comprising a service flow update indicator, information on a current MBS ID and flow ID to be updated which are described by a value of the service flow update indicator, and new MBS information,
wherein the information on the current MBS ID and flow ID is the current MBS ID and flow ID when the service flow update indicator has a first value, and
wherein the information on the current MBS ID and flow ID is an index for a combination of the current MBS ID and flow ID when the service flow update indicator has a second value.

15. A method of updating multicast and broadcast service (MBS) in a terminal, the method comprising:
transmitting a dynamic service change request message to a base station; and
receiving a dynamic service change response message from the base station when MBS information is updated, the dynamic service change response message comprising a service flow update indicator, information on a current MBS ID and flow ID to be updated which are described by a value of the service flow update indicator, and new MBS information,
wherein the information on the current MBS ID and flow ID is the current MBS ID and flow ID when the service flow update indicator has a first value, and
wherein the information on the current MBS ID and flow ID is an index for a combination of the current MBS ID and flow ID when the service flow update indicator has a second value.

16. A method of updating multicast and broadcast service (MBS) in a terminal, the method comprising:
receiving a dynamic service change request message from a base station when MBS information is updated, the dynamic service change request message comprising a service flow update indicator, information on a current MBS ID and flow ID to be updated which are described by a value of the service flow update indicator, and new MBS information; and
transmitting a dynamic service change response message to the base station,
wherein the information on the current MBS ID and flow ID is the current MBS ID and flow ID when the service flow update indicator has a first value, and
wherein the information on the current MBS ID and flow ID is an index for a combination of the current MBS ID and flow ID when the service flow update indicator has a second value.
